(19) United States
(12) Patent Application Publication
(10) Pub. No.: US 2003/0075159 A1
(43) Pub. Date: Apr. 24, 2003

(54) EGR valve apparatus

(76) Inventors: Dimitri L. Vamvakitis, Pontiac, MI (US); Richard J. Vaughan, Ormond Beach, FL (US); Jerry Holden, Smithville, TN (US)

Correspondence Address: CARLSON, GASKEY & OLDS, P.C., 400 WEST MAPLE ROAD, SUITE 350, BIRMINGHAM, MI, 48009, US

(21) Appl. No.: 10/286,158

(22) Filed: Oct. 30, 2002

Related U.S. Application Data
(63) Continuation-in-part of application No. PCT/US01/14200, filed on May 3, 2001.
(60) Provisional application No. 60/201,391, filed on May 3, 2000.
(60) Provisional application No. 60/234,432, filed on Sep. 21, 2000.
(60) Provisional application No. 60/235,828, filed on Sep. 27, 2000.

(51) Int. Cl. F02M 25/07

(52) U.S. Cl. 123/568.21; 123/568.23

(57) ABSTRACT

An EGR valve apparatus (16) regulates the amount of exhaust gas recirculated in an EGR system. The EGR valves (28) are opened or closed by a rotatable shaft (30) which is actuated by a motor (14). Alternatively, the valves can be balanced on the shaft, the valves moving in opposing direction during rotation. An inline poppet can be employed to overcome pressure in the system prior to movement of the valves. In another alternative embodiment, the motor rotates threaded shaft to move a pintle towards and away from an orifice.

### BACKGROUND OF THE INVENTION

The present invention relates generally to an exhaust gas recirculation (EGR) system for regulating the flow of an exhaust gas.

EGR systems are increasingly being utilized to improve the efficiency of engines and reduce the harmful effects of the exhaust gas on the environment. As an engine burns fuel, it produces an exhaust gas which contains unburned fuel and other impurities. In an EGR system, the exhaust gas is redirected through the engine to burn any unburned fuel remaining in the exhaust gas. Rebuming the exhaust gas before it is released reduces the harmful effects of the exhaust gas on the atmosphere and enables the vehicle to meet government emission standards.

In order to recirculate the exhaust gas, EGR systems typically include a valve and a cooler. The valve regulates the amount of exhaust gas that is introduced back into the engine. The cooler cools the exhaust gas to a specified temperature which condenses the unburned fuel.

Prior EGR systems utilize a vacuum source with a diaphragm actuator to open and close the valve. The diaphragm actuator has a slow response time and is either open or closed with no intermediate valve position. One drawback to the prior art is that the slow response time of valves reduce the horsepower and efficiency of the engine, limiting the amount the EGR system may be used.

Hence, there is a need for an improved exhaust gas recirculation system for regulating the flow of an exhaust gas.

### SUMMARY OF THE INVENTION

The present invention relates to an exhaust gas recirculation system for regulating the flow of an exhaust gas.

The exhaust gas recirculation system includes an EGR valve apparatus which regulates the amount of exhaust gas that is recirculated in the system. In one embodiment, a motor rotates a shaft which opens or closes a plurality of valves. The amount of exhaust gas flowing through the EGR valve apparatus is proportional to the amount the valves are opened or closed.

In a second embodiment, a force balanced rotary EGR valve assembly including balance seat valves is utilized. When more exhaust is to enter a chamber, the shaft is rotated, moving a downward balanced seat rotary EGR valve downwardly out of the chamber against the flow of exhaust and an upward balanced seat rotary EGR valve upwardly into the chamber with the flow of exhaust. Rotating the shaft in the opposite direction reverses the movement of the valves, allowing less exhaust gas to enter the chamber.

A third embodiment includes an inline poppet located on each valve which opens to allow gas to enter the chamber before the EGR valve is opened to overcome the pressure in the system. A cam translates the rotary motion of the motor shaft to the linear motion of a valve shaft to open the EGR valve.

Alternatively, the motor rotates the motor shaft to pivot a balance arm in a fourth embodiment. A first end of the arm moves upwardly to raise an EGR valve, and a second end of the arm moves downwardly to lower an EGR valve, allowing more exhaust gas to enter the chamber. Reverse rotation of the shaft reverses the movement of the valves, allowing less exhaust gas to enter the chamber.

In a fifth embodiment, an air venturi apparatus is employed. The motor rotates a shaft of a poppet, separating a pintle from an orifice. The degree of separation of the pintle from the orifice allows a proportional amount of a fresh air/exhaust gas mixture to return to the system.

Accordingly, the present invention provides an exhaust gas recirculation system for regulating the flow of an exhaust gas.

These and other features of the present invention will be best understood from the following specification and drawings.

### BRIEF DESCRIPTION OF THE DRAWINGS

The various features and advantages of the invention will become apparent to those skilled in the art from the following detailed description of the currently preferred embodiment. The drawings that accompany the detailed description can be briefly described as follows:

FIG. 1 illustrates a flow diagram for an exhaust recirculation system which regulates the flow of an exhaust gas;

FIG. 2 is a perspective view of a first embodiment of the valve apparatus of the present invention;

FIG. 3 illustrates a perspective view of a second embodiment of the valve apparatus employing a forced balanced seat EGR valve assembly;

FIG. 4 illustrates a cross sectional side view of the valves of the force balanced rotary EGR valve assembly of the second embodiment;

FIG. 5 illustrates an interior cross sectional view of a third embodiment of the valve apparatus with the force balanced rotary valves opened;

FIG. 6 illustrates an interior cross sectional view of a fourth embodiment of the valve apparatus; and

FIG. 7 illustrates a perspective internal view of an air venturi assembly of a fifth embodiment of the present invention.

### DETAILED DESCRIPTION OF THE PREFERRED EMBODIMENT

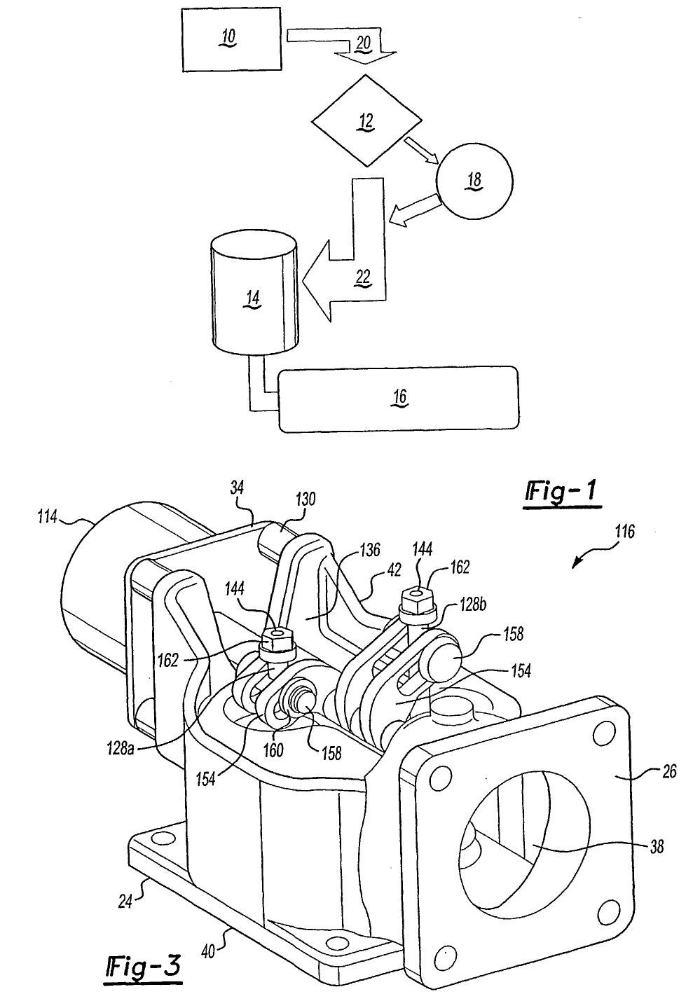

The exhaust gas recirculation (EGR) system, illustrated in FIG. 1, comprises an engine control unit (ECU) 10 which transits a pulse width modulated (PWM) signal 20 to a printed circuit board (PCB) pilot circuit 12. A PWM signal 20 is not strong enough to operate a motor 14, the pilot circuit 12 is connected to a second current source 18, such as a battery, which increases the strength of the PWM signal 20. The pilot circuit 12 then transmits a second signal 22 to the motor 14, which actuates a valve apparatus 16 to control the flow of a fresh air/exhaust gas mixture back into the system. It is preferred that the motor 14 is an electric D/C motor 14, preferably a monophase electromagnetic actuator.

The ECU 10 is programmed to operate the EGR system at certain customer specified duty cycles. As a vehicle travels at a constant speed, the ECU 10 transmits a signal to operate the EGR system at full capacity. However, when the vehicle requires maximum horsepower, such as during acceleration, the ECU 10 transmits the PWM signal 20 to close the valves apparatus 16, to step exhaust gas recirculation. The ECU 10 is limited by being able to transmit a signal of no more than 1.3 amps.

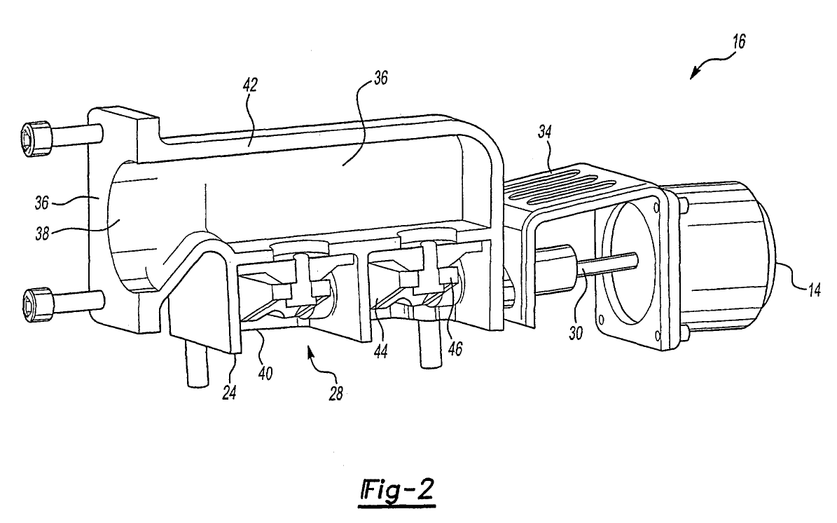

FIG. 2 illustrates a first embodiment of the EGR valve apparatus 16 of the present invention. A non-contact sensor of the motor 14 receives a signal from the pilot circuit 12 and in response rotates a shaft 30 to proportionally open or close a plurality of valves 28. The motor 14 is attached to a housing 42 by a bracket 34, which provides support for the shaft 30 and withstands the torque produced as the shaft 30 rotates.

Each of the valves 28 includes an arm 44 connected to a disc 46 by a pin. As the shaft 30 rotates, the arm 44 pivots and the disc 46 moves, opening and closing the valves 28. In this embodiment, each of the valves 28 are substantially positioned on the same side of the shaft 30.

After the valves 28 have been opened, exhaust gas flows from the engine, which is fastened to the housing 42 at a first mounting face 24, through an exhaust gas inlet 40. The exhaust gas enters a chamber 36 and exits the valve assembly 16 through the outlet 38. The exhaust gas then flows into a cooler, which is fastened to the housing 42 at a second mounting face 26. While multiple valves are shown for increased exhaust gas flow, only one may be used if desired.

In a second embodiment, as illustrated in FIG. 3, a valve assembly 116 including force balanced seat rotary EGR valves 128 is utilized. As the motor 114 operates, the shaft 130 rotates to proportionally raise and lower the rotary EGR valves 128 allowing exhaust to enter the chamber 136 from the engine. While a pair of force balanced rotary EGR valves 128 are illustrated, any number may be utilized. In this embodiment, the rotary EGR valves 128 are positioned on opposite sides of the shaft 130.

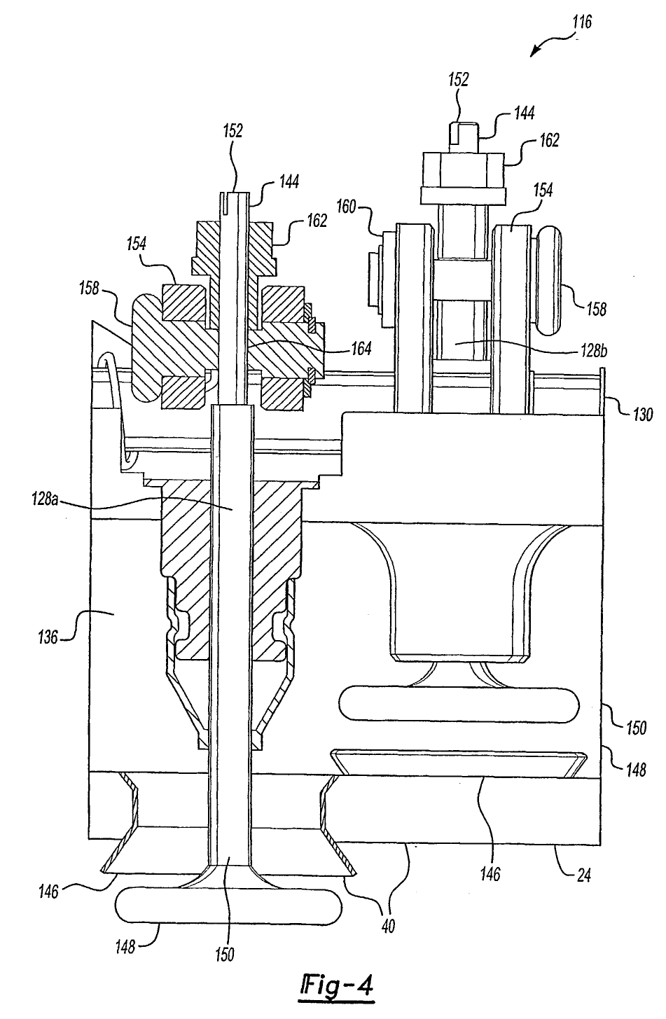

As illustrated in FIG. 4, each rotary EGR valve 128 includes a pintle 148 attached to a bottom portion 150 of a valve shaft 144. When more exhaust is to enter the system, the shaft 130 is rotated so that the downward rotary EGR valve 128a moves downwardly out of the chamber 126 against the flow of exhaust, and the upward rotary EGR valve 128b moves upwardly into the chamber 136 with the flow of exhaust. The degree of rotation of the shaft 130 determines the amount the rotary EGR valves 128a, 128b are opened. It is preferred that the shaft 130 be rotated 20°, although other degrees of rotation are possible depending on system requirements. When less exhaust is to enter the system, the shaft 130 is rotated in the opposite direction, reversing the abovementioned movement of the valves 128a, 128b. When no exhaust is to enter the system, the pintles 148 of the rotary EGR valves 128 fit securely into an orifice 146 cut into the first mounting face 124 of the housing 142, preventing exhaust from being recirculated into the system.

As further illustrated in FIG. 4, an upper portion 152 of each valve shaft 144 is attached to a curved arm 154 secured to the motor shaft 130 by a pin 158, the valve shaft 144 being positioned within an orifice 164 in the pin 158. Wave washers 160 are utilized to reduce wear. A threaded nut 162 positioned on the upper portion 152 of the valve shaft 144 secures the assembly.

As the motor 114 rotates the shaft 130 according to the required input, the arms 154 pivot and transfer the rotational movement of the shaft 130 into the linear movement of the rotary EGR valves 128a, 128b. A spring can be employed on the motor shaft 130 proximate to the motor 114 to prevent vibrations and to act as a fail safe mechanism to close the valves 128a, 128b if the motor 114 loses power.

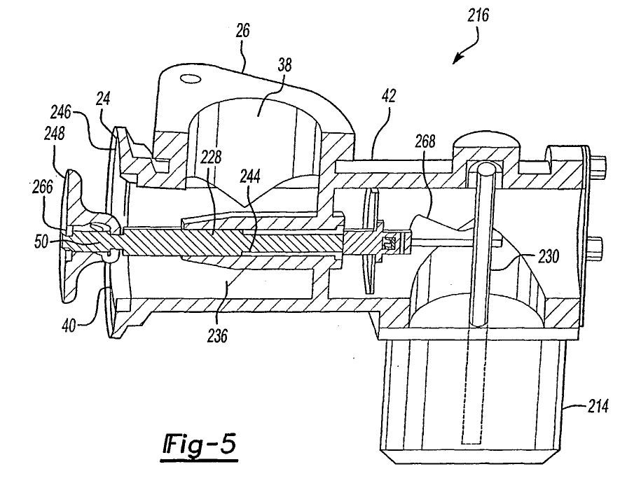

FIG. 5 illustrates a third embodiment of the EGR valve assembly 216 in an open position. An inline poppet 266 located on the pintle 248 opens to allow gas to enter the chamber 236 before the EGR valve 228 is opened. This overcomes the pressure in the system, reducing the force needed to open the EGR valve 228. The motor 214 rotates a shaft 230 which is connected to a cam 268, the cam 268 translating the rotary motion of the motor shaft 230 to the linear motion of the valve shaft 244 and opens the EGR valve 228. The degree of rotation of the motor shaft 230 determines the degree of the opening of the EGR valve 228. Rotation of the motor shaft 230 moves the pintle 248 towards or away from the orifice 246 to allow the desired amount of exhaust gas to enter the chamber 236.

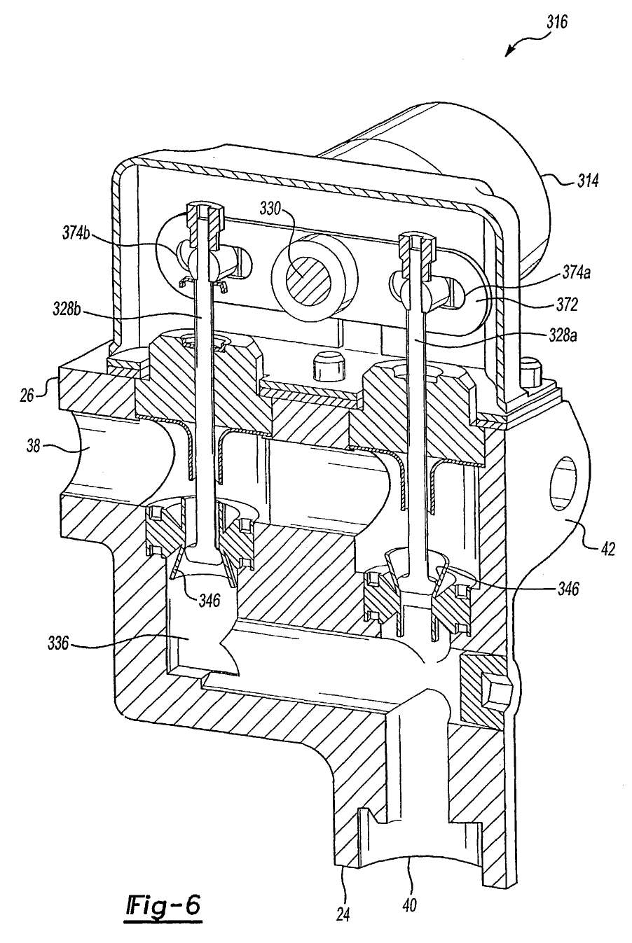

FIG. 6 illustrates a fourth embodiment of valve assembly 316. The motor 314 rotates a motor shaft 330, pivoting a balance arm 372 so that a first end 374b of the arm 372 moves upwardly to raise the rotary EGR valve 328b, and the second end 374a of the arm 372 moves downwardly to lower the rotary EGR valve 328a. As the valves 328a, 328b move away from their respective orifices 346, more exhaust gas is allowed to enter the chamber 336. Reverse rotation of the shaft 330 reverses the movement of the valves 328a, 328b. The degree of the opening of the valves 328a, 328b is determined by the ECU 10.

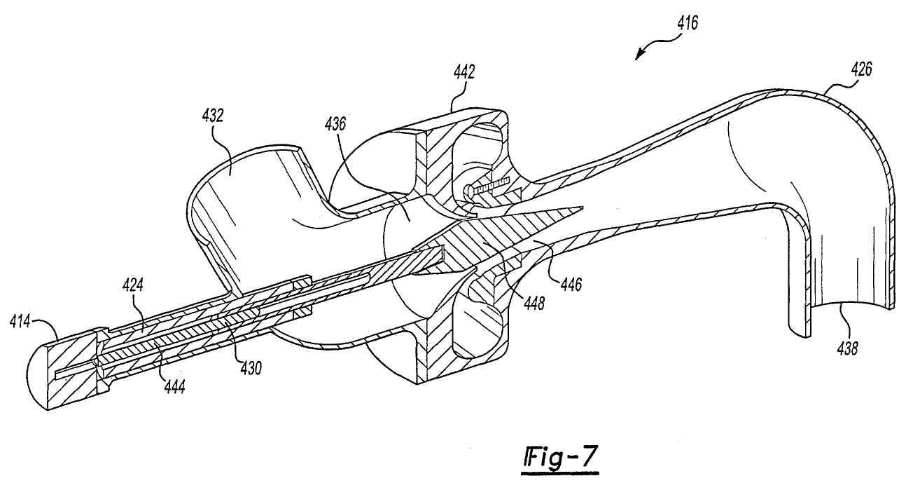

FIG. 7 illustrates an air venturi valve apparatus 416. Fresh air enters from a fresh air inlet 432 in a first elongated tube 424 and exhaust gas enters from an exhaust gas inlet, mixing in a chamber 436 of a housing 442. The fresh air/exhaust gas mixture exits the housing 442 through a fresh air/exhaust gas mixture outlet 438 in a second elongated tube 426, leading back to the system.

When the fresh air/exhaust gas mixture is to be released back into the system, the motor 414 rotates a shaft 444 of a poppet 430 threaded in the first elongated tube 424, separating a pintle 448 from an orifice 446. As the pintle 448 moves away, the fresh air/exhaust gas mixture passes through the orifice 446 and into the system. The farther away the pintle 448 is positioned from the orifice 446, the more fresh air/exhaust gas mixture is allowed to pass through the orifice 446 and back into the system.

By rotating the threaded valve shaft 444, the pintle 448 of the poppet 430 can be repositioned depending on the system requirements. When no fresh air/exhaust gas mixture is to be allowed back into the system, the valve shaft 444 is rotated such that the pintle 448 is secured in the orifice 446, blocking the flow of fresh air/exhaust gas into the second elongated tube 426 and into the system.

There are many advantages to operating the EGR system with the electric D/C motor 14. First, the motor 14 can proportionally open the valves 28, allowing for various flow ranges. Secondly, the motor 14 achieves a faster response than the vacuum actuators of the prior art. Additionally, this EGR system reduces space requirements within the engine compartment due to the compact size of the motor 14.

The foregoing description is exemplary rather then defined by the limitations within. Many modifications and variations of the present invention are possible in light of the above teachings. The preferred embodiments of this invention have been disclosed, however, so that one of ordinary skill in the art would recognize that certain modifications would come within the scope of this invention.

1. An exhaust gas recirculation system for regulating a flow of an exhaust gas comprising:
a engine control unit which generates a signal;
a motor electrically connected to said engine control unit for receiving said signal;
a valve apparatus comprising at least one valve being coupled to said motor for actuating said at least one valve between a plurality of positions; and
a pilot circuit interposed between said engine control unit and said motor for modifying said signal to actuate said valve to one of said plurality of positions.

2. The exhaust gas recirculation system as recited in claim 1 wherein said at least one valve is coupled to a shaft rotatable by said motor, rotation of said shaft actuating said at least one valve to one of said plurality of positions.

3. The exhaust gas recirculation system as recited in claim 2 wherein said at least one valve is actuated an amount proportional to a degree of rotation of said shaft.

4. The exhaust gas recirculation system as recited in claim 2 wherein each of said at least one valve is positioned on substantially a same side of said shaft, rotation of said shaft actuating each of said at least one valve to one of said plurality of positions, each of said at least one valve moving in substantially the same direction.

5. The exhaust gas recirculation system as recited in claim 2 wherein each of said at least one valve and an opposing valve are positioned on substantially opposing sides of said shaft, rotation of said shaft actuating each of said at least one valve in a direction and actuating said opposing valve in an opposing direction.

6. The exhaust gas recirculation system as recited in claim 5 wherein each of said at least one valve and said opposing valve are operatively connected to a pivotable arm positioned on said shaft, said arm transferring rotational movement of said shaft to linear movement of each of said at least one valve and said opposing valve.

7. The exhaust gas recirculation system as recited in claim 5 wherein each of said at least one valve and said opposing valve includes a pintle substantially engagable into an orifice.

8. The exhaust gas recirculation system as recited in claim 7 wherein rotation of said shaft in a first direction proportionally moves said pintle substantially towards said orifice to reduce said flow of said exhaust gas through said orifice.

9. The exhaust gas recirculation system as recited in claim 7 wherein rotation of said shaft in a second direction moves said pintle substantially away from said orifice to increase said flow of said exhaust gas through said orifice.

10. The exhaust gas recirculation system as recited in claim 2 wherein said valve apparatus further includes a poppet which actuates to reduce pressure in said valve apparatus before said at least one valve actuates between said plurality of positions.

11. The exhaust gas recirculation system as recited in claim 2 wherein said valve apparatus further includes an arm pivotally connected to said shaft, said at least one valve positioned on a first end of said arm and an opposing valve positioned on an opposing second end of said arm, rotation of said shaft moving said first end and said second end in opposing directions to actuate each of said at least on valve and said opposing valve in substantially opposing directions.

12. The exhaust gas recirculation system as recited in claim 2 wherein said shaft is substantially threaded, rotation of said shaft actuating said at least one valve between said plurality of positions.

13. The exhaust gas recirculation system as recited in claim 12 wherein each of said at least one valve includes a pintle substantially engagable into an orifice.

14. The exhaust gas recirculation system as recited in claim 12 wherein rotation of said threaded shaft in a first direction proportionally actuates said pintle substantially towards said orifice to reduce said flow of said exhaust gas through said orifice.

15. The exhaust gas recirculation system as recited in claim 12 wherein rotation of said threaded shaft in a second direction proportionally actuates said pintle substantially away from said orifice to increase said flow of said exhaust gas through said orifice.

16. The exhaust gas recirculation system as recited in claim 12 wherein said exhaust gas further includes a fresh air exhaust mixture, rotation of said threaded shaft between said plurality of positions allowing a desired amount of said exhaust gas to pass through said orifice.

17. The exhaust gas recirculation system as recited in claim 1 wherein said exhaust gas enters said system from an engine and exits said system into a cooler.

18. An exhaust gas recirculation system for regulating a flow of an exhaust gas comprising:
a motor electrically connected to said engine control unit for receiving a signal; and
a valve apparatus coupled to said motor including at least one valve, each of said at least one valve positioned on substantially a same side of a shaft rotatable by said motor, rotation of said shaft actuating each of said at least one valve in substantially the same direction to one of a plurality of positions.

19. The exhaust gas recirculation system as recited in claim 18 wherein said at least one valve is actuated an amount proportional to a degree of rotation of said shaft.

20. An exhaust gas recirculation system for regulating a flow of an exhaust gas comprising:
a motor electrically connected to said engine control unit for receiving a signal; and
a valve apparatus coupled to said motor including at least one valve and an opposing valve positioned on substantially opposing sides of a shaft rotatable by said motor, rotation of said shaft actuating each of said at least one valve and opposing valve in opposing directions to one of a plurality of positions.

21. The exhaust gas recirculation system as recited in claim 20 wherein said at least one valve is actuated an amount proportional to a degree of rotation of said shaft.

22. The exhaust gas recirculation system as recited in claim 20 wherein each of said at least one valve and said opposing valve are operatively connected to a pivotable arm positioned on said shaft, said arm transferring rotational movement of said shaft to linear movement of each of said at least one valve and said opposing valve.

23. The exhaust gas recirculation system as recited in claim 20 wherein each of said at least one valve and said opposing valve includes a pintle substantially engagable into an orifice.

24. The exhaust gas recirculation system as recited in claim 20 wherein said valve apparatus further includes a poppet which actuates to reduce pressure in said valve apparatus before said at least one valve actuates between said plurality of positions.

25. The exhaust gas recirculation system as recited in claim 20 wherein said valve apparatus further includes an arm pivotally connected to said shaft, said at least one valve positioned on a first end of said arm and an opposing valve positioned on an opposing second end of said arm, rotation of said shaft moving said first end and said second end in opposing directions to actuate each of said at least on valve and said opposing valve in substantially opposing directions.

26. An exhaust gas recirculation system for regulating a flow of an exhaust gas comprising:
a motor electrically connected to said engine control unit for receiving a signal; and
a valve apparatus coupled to said motor comprising at least one valve including a substantially threaded shaft rotatable by said motor, rotation of said shaft actuating said at least one valve to one of a plurality of positions.

27. The exhaust gas recirculation system as recited in claim 26 wherein said at least one valve is actuated an amount proportional to a degree of rotation of said shaft.

28. The exhaust gas recirculation system as recited in claim 26 wherein each of said at least one valve includes a pintle substantially engagable into an orifice.

29. The exhaust gas recirculation system as recited in claim 26 wherein said exhaust gas further includes a fresh air exhaust mixture, rotation of said threaded shaft between said plurality of positions allowing a desired amount of said exhaust gas to pass through said orifice.

30. A method for regulating a flow of an exhaust gas in an exhaust gas recirculation system comprising the steps of:
generating a signal by an engine control unit;
receiving said signal by a motor electrically connected to said engine control unit;
modifying said signal by a pilot circuit interposed between said engine control unit and said motor; and
actuating at least one valve of a valve apparatus coupled to said motor between a plurality of positions.

31. A method for regulating a flow of an exhaust gas in an exhaust gas recirculation system comprising the steps of:
rotating a shaft coupled to a motor;
actuating at least one valve to one of a plurality of positions an amount proportional to a degree of rotation of said shaft.
